(19) United States
(12) Patent Application Publication
(10) Pub. No.: US 2009/0291185 A1
(43) Pub. Date: Nov. 26, 2009

(54) EDIBLE MODELING MATERIAL

(76) Inventor: Stefan Kaczmarek, Idstein (DE)

Correspondence Address: ROBERTS & ROBERTS, LLP;ATTORNEYS AT LAW, P.O. BOX 484, PRINCETON, NJ, 08542-0484, US

(21) Appl. No.: 12/539,233

(22) Filed: Aug. 11, 2009

Related U.S. Application Data
(63) Continuation-in-part of application No. 12/443,073.

(30) Foreign Application Priority Data
Sep. 28, 2006 (DE) 20 2006 015 009.9

(51) Int. Cl. A21D 13/06; A21D 10/00

(52) U.S. Cl. 426/549

(57) ABSTRACT

The invention relates to an edible modeling material which is a kneadable and moldable baking mixture, including a proportion of sweetener of from 0% to about 50% by weight, a proportion of flour of from about 10% to about 50% by weight, a proportion of starch of from 0% to about 20% by weight, a proportion of water of from about 5% to about 30% by weight, a proportion of animal and/or vegetable protein of from 0% to about 5% by weight, and a proportion of animal and/or vegetable fat of from 0% to about 5% by weight.

### CROSS REFERENCE TO RELATED APPLICATION

This application is a continuation-in-part of co-pending U.S. patent application Ser. No. 12/443,073 filed Mar. 26, 2009, which was filed as a U.S. National Phase entry of PCT/EP2007/058616 filed Aug. 20, 2007, which is incorporated herein by reference.

The subject of the present invention is an edible modeling material which is a kneadable and moldable baking mixture which, for one, has a good kneading consistency in the raw state and, on the other hand, is dimensionally stable to the greatest extent during curing in the oven and tastes good afterwards.

A multitude of modeling materials is known, which contain wax and/or oil as binders (DE 202 00 796 U1, DE 102 01 946 B4 and DE 20 2006 001 786 U1). Furthermore, a material for kneading is known, which consists of glycerin, tensides and dyes (DE 103 39 807 A1). However, all these compositions have the disadvantage that they are not suitable for eating.

Therefore the object of the present invention was to make available an edible modeling material which is a baking mixture which, in the raw state, has a good kneading consistency and does not adhere to fingers or the supporting surface and, following curing, results in mechanically stable figures, and furthermore tastes good at each stage of use.

This object was attained by an edible modeling material and kneading and baking mixture having a proportion of sweetener of from 0% to about 50% by weight, a proportion of flour of from about 10% to about 50% by weight, a proportion of starch of from 0% to about 20% by weight, a proportion of water of from 5% to about 30% by weight, a proportion of animal and/or vegetable protein of from 0% to about 5% by weight, and a proportion of animal and/or vegetable fat of from 0% to about 15% by weight.

Such an edible modeling material and baking mixture in accordance with the invention is distinguished by good kneading consistency and tastes good as well. The mixture in accordance with the invention does not adhere to fingers or the supporting surface but does, however, allow the adherence of independently shaped figure elements to each other, and can therefore be used as an edible modeling material by children in particular. In this connection it is of particular advantage that the baking mixture tastes good at any time during its use.

In connection with an advantageous embodiment of the edible modeling material and baking mixture in accordance with the invention, it contains a proportion of sweetener of from about 20% to about 40% by weight, a proportion of flour of from about 20% to about 40% by weight, a proportion of starch of from about 5% to about 15% by weight, a proportion of water of from about 15% to about 25% by weight, a proportion of animal and/or vegetable protein of from about 1% to about 3% by weight, and a proportion of animal and/or vegetable fat of from about 8% to about 12% by weight.

It is particularly advantageous if the edible modeling material and baking mixture of the invention contains sugar, preferably sugar refined from sugar cane or sugar beets, or sugar from starch, dextrose, vanilla sugar, powdered sugar, inverted sugar or hybrid sugar.

It is possible for the purpose of an advantageous embodiment to selectively use wheat flour, rye flour, spelt and/or soy flour for the baking mixture. Preferably, the starch can be gluten-free cornstarch, or potato starch, wheat starch or rice starch.

Furthermore, in an advantageous embodiment variation of the invention, it can contain dried chicken protein or milk powder as the animal protein, and dried chicken egg yolk as the animal fat. Such a dry baking mixture has a good shelf life and can be offered as a finished mix. For producing a ready-to-use edible modeling material and kneadable and moldable baking mixture, the required proportion of water is added to the dry, powder-like ready mix. This means that it is only necessary to add tap water to the ready mix of sweetener, flower, starch, animal and/or vegetable protein, was well as animal and/or vegetable fat, in order to obtain the edible modeling material and kneadable and moldable baking mixture. Such a ready mix can for example be offered in paper and/or cardboard packaging, or in plastic containers. It is also possible to offer the edible modeling material and kneadable and moldable baking mixture in accordance with the invention ready for use, i.e. including the water proportion, in appropriate plastic containers, in which case preservatives are additionally required.

In a further advantageous embodiment of the invention, the respective proportion of animal protein, animal fat and the water portion of the ready-to-use baking mixture, which only contains sweetener, flour and starch, is alternatively achieved by adding the egg white and the egg yolk of a raw chicken egg. This ready mix, too, without the components of the egg, can for example be offered in cardboard packaging or in plastic containers.

Furthermore, the ready-to-use edible modeling material and baking mixture can contain vegetable oil, or for example peanut butter, as the vegetable fat.

It is furthermore possible to add portions of honey to the baking mixture. Additional proportions of nutrients and/or nutritious additives are contained in an advantageous embodiment variation of the baking mixture. For this purpose it is possible to add calcium, various vitamins and/or trace elements in particular. It can furthermore be of advantage to add aromatic substances, such as vanilla, lemon or cinnamon, for example, or to knead in chocolate.

The edible modeling material and baking mixture in accordance with the invention is also distinguished in that it well absorbs food coloring. It is thus possible to achieve the desired coloration by the addition of appropriate proportions of food coloring, while the baking mixture in accordance with the invention assures only slight discoloration during curing in the oven.

Because of the low proportion of fat, the edible modeling material and baking mixture in accordance with the invention avoids large stains on the supporting surface in the course of kneading. The edible modeling material and baking mixture in accordance with the invention has the advantage that figures, in particular those kneaded by children, are dimensionally stable to the greatest extent during baking, and the finished baked goods taste good.

Following a first kneading process, the ready-to-use edible modeling material and baking mix is stored for a few hours in a refrigerator at from about 4° C. to about 8° C. and can subsequently be shaped in the form of edible modeling material into appropriate figures. After the ripening process in the refrigerator, it is possible to again add a little cornstarch for improving kneadability. Curing of the shaped figures takes place by means of a baking process of from about 15 to about 30 minutes, preferably about 25 minutes, at from about 100° C. to about 150° C., preferably about 120° C.

Use of the edible modeling material in play has a particular educational value, since modeling prompts creativity. Starting in the second year of life, it is important for children to gain sensor capabilities by touching, shaping and dividing. In the process, kneading also aids the motor functions. In older children, recognition, imagination and creativity are more encouraged. In this connection the use of strong colors is matched to the needs of the children in particular.

Modeling material is successfully employed in the therapy of children suffering from speech defects or motor defects. Modeling material is furthermore also employed in adult therapy, such as for example in case of hand or wrist operations, or in case of rheumatic troubles.

The edible modeling material can also be employed in connection with therapeutic baking. Here, the edible molding material is used in the course of kneading, as well as baking.

For understanding the invention further, an exemplary embodiment will be described in what follows.

### EXAMPLE 1

200 g of powdered sugar, 250 g of wheat flour, two tablespoons of cornstarch and two medium-sized chicken eggs are mixed together and kneaded for 15 minutes, in the course of which a little cornstarch was again added. After molding the desired figures, baking takes place at 120° C. for 25 minutes.

### EXAMPLE 2

360 g of pastry flour, 225 g of icing sugar, 30 g of whole egg powder, 150 g of powdered shortening and 80 g of wheat starch are mixed together with 6 g of strawberry flavor, 0.5 g of a red colorant for bakery products (E 162) and 3 g of lecithin powder and 200 g of water and are kneaded for 15 minutes, in the course of which a little cornstarch was added. The mixture is well suitable for molding. After molding the desired figures, baking takes place at 120° C. for 25 minutes.

### EXAMPLE 3

380 g of pastry flour, 245 g of icing sugar, 30 g of whole egg powder, 110 g of 10 powdered shortening and 60 g of wheat starch are mixed together with 6 g of lemon flavor, 0.5 g of a yellow colorant for bakery products' (E 100) and 3 g of lecithin powder and 200 g of water and are kneaded for 15 minutes, in the course of which a little cornstarch was added. The mixture is well suitable for molding. After molding the desired figures, baking takes place at 120° C. for 25 minutes.

### EXAMPLE 4

370 g of pastry flour, 215 g of icing sugar, 30 g of whole egg powder, 130 g of 20 powdered shortening and 60 g of wheat starch are mixed together with 6 g of vanilla flavor, 0.5 g of an orange colorant for bakery products (E 100) and 3 g of lecithin powder and 200 g of water and are kneaded for 15 minutes, in the course of which a little cornstarch was added. The mixture is well suitable for molding. After molding the desired figures, baking takes place at 120° C. for 25 minutes.

### EXAMPLE 5

400 g of pastry flour, 250 g of icing sugar, 30 g of whole egg powder, 130 g of 30 powdered shortening and 40 g of wheat starch are mixed together with 6 g of cinnamon flavor, 0.5 g of a green colorant for bakery products (E 140) and 3 g of lecithin powder and 200 g of water and are kneaded for 15 minutes, in the course of which a little cornstarch was added. The mixture is well suitable for molding. After molding the desired figures, baking takes place at 120° C. for 25 minutes.

### EXAMPLE 6

375 g of pastry flour, 245 g of icing sugar, 30 g of whole egg powder, 120 g of powdered shortening and 40 g of wheat starch are mixed together with 6 g of chocolate flavor, 0.5 g of a brown colorant for bakery products (E 150) and 3 g of lecithin powder and 200 g of water and are kneaded for 15 minutes, in the 10 course of which a little cornstarch was added. The mixture is well suitable for molding. After molding the desired figures, baking takes place at 120° C. for 25 minutes.

### EXAMPLE 7

The ingredients in the following table are combined and kneaded for 15 minutes. The mixture is well suitable for molding. After molding the desired figures, baking takes place at 120° C. for 25 minutes.

| | Weight | Weight | Weight | In Finished |
|---|---|---|---|---|
| Description | (Lb) | (Kg) | (g) | Knead |
| Icing Sugar | 0.99 | 0.45 | 450.00 | 26.16% |
| Unbleached Pastry Flour | 1.59 | 0.72 | 720.00 | 41.86% |
| Whole Egg Powder | 0.15 | 0.07 | 68.04 | 3.96% |
| Powdered Shortening | 0.38 | 0.17 | 170.10 | 9.89% |
| Wheat Starch | 0.23 | 0.10 | 102.06 | 5.93% |
| Green Apple Flavor | 0.01 | 0.01 | 6.00 | 0.35% |
| (Givaudan) | | | | |
| Yellow #5 Colorant | 0.00 | 0.00 | 0.300 | 0.02% |
| Blue #1 Colorant | 0.00 | 0.00 | 0.075 | 0.00% |
| Lecithin Powder | 0.00 | 0.00 | 2.25 | 0.13% |
| Water | 0.44 | 0.20 | 201.25 | 11.70% |
| Batch Yield | 3.79 | 1.72 | 1720.07 | |

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. An edible modeling material comprising:
a proportion of sweetener of from 0% to about 50% by weight,
a proportion of flour of from about 10% to about 50% by weight,
a proportion of starch of from 0% to about 20% by weight,
a proportion of water of from about 5% to about 30% by weight,
a proportion of animal and/or vegetable protein of from 0% to about 5% by weight, and
a proportion of animal and/or vegetable fat of from 0% to about 5% by weight.

2. The edible modeling material in accordance with claim 1, wherein the sweetener comprises refined sugar from sugar cane or sugar beets, or sugar from starch, dextrose, vanilla sugar, powdered sugar, inverted sugar or hybrid sugar.

3. The edible modeling material in accordance with claim 1 wherein the flour comprises wheat flour, rye flour, spelt and/or soy flour.

4. The edible modeling material in accordance with claim 3, wherein the flour is present in a proportion of from about 20% to about 40% by weight.

5. The edible modeling material in accordance with claim 1 wherein the starch comprises potato starch, wheat starch, rice starch, or corn starch.

6. The edible modeling material in accordance with claim 5, wherein the starch is present in a proportion of from about 5% to about 15% by weight.

7. The edible modeling material in accordance with claim 1 wherein the water is present in a proportion of from about 15% to about 25% by weight.

8. The edible modeling material in accordance with claim 1 wherein the protein comprises dried chicken protein or milk powder.

9. The edible modeling material in accordance with claim 1 wherein the animal fat comprises dried chicken egg yolk.

10. The edible modeling material in accordance with claim 1 wherein the animal protein, animal fat and the water are from an egg yolk from a raw chicken egg.

11. The edible modeling material in accordance with claim 1 wherein the fat comprises peanut butter or a vegetable oil.

12. The edible modeling material in accordance with claim 11, wherein the fat is present in a proportion of about 1.5% by weight.

13. The edible modeling material in accordance with claim 1 which comprises honey.

14. The edible modeling material in accordance with claim 1 which further comprises at least one of calcium, vitamins and/or nutrients.

15. The edible modeling material in accordance with claim 1 which further comprises at least one of aromatic substances, vanilla, lemon, cinnamon, or chocolate.

16. The edible modeling material in accordance with claim 1 which further comprises a food dye.

17. A method for producing formed figures comprising:
providing the edible modeling material of claim 1;
kneading the edible modeling material;
storing the edible modeling material at from about 4° C. to about 8° C.;
subsequent forming the edible modeling material into a figure;
baking the formed figure at from about 100° C. to about 150° C. for from about 15 minutes to about 30 minutes to harden the figure.

18. The method as claimed in claim 17, wherein the baking is conducted at about 120° C. for about 25 minutes.

19. The edible modeling material of claim 1 comprising:
a proportion of sugar of up to 32% by weight,
a proportion of flour of 10% to 50% by weight,
a proportion of starch of 0% to 20% by weight,
a proportion of water of 5% to 30% by weight,
a proportion of animal and/or vegetable protein of 1.5% by weight, and
a proportion of animal and/or vegetable fat of 0% to 5% by weight.
